(19) United States
(12) Patent Application Publication
(10) Pub. No.: US 2006/0028088 A1
(43) Pub. Date: Feb. 9, 2006

(54) Bearing support for motors

(76) Inventors: Dalton E. McFarland, Medina, TN (US); Bobby O. Thurmond JR., Jackson, TN (US); Stephen F. Vernaglia, Perrysburg, OH (US); Stephen D. Rogers, Greer, SC (US); Mark W. Wood, Jackson, TN (US); James T. Breeden, Jackson, TN (US)

Correspondence Address: SUITER WEST SWANTZ PC LLO, 14301 FNB PARKWAY, SUITE 220, OMAHA, NE, 68154, US

(21) Appl. No.: 11/193,009

(22) Filed: Jul. 29, 2005

Related U.S. Application Data
(60) Provisional application No. 60/599,405, filed on Aug. 6, 2004.

(51) Int. Cl. H01R 39/38

(52) U.S. Cl. 310/239

(57) ABSTRACT

A motor mounting and a motor configured for simplified assembly. The motor mounting is configured for including a bearing, the bearing for receiving a rotor shaft therein. The motor mounting is configured to accept a brush assembly received from an exterior surface. The brush assembly and motor mounting may be constructed to permit coupling in a tool-less manner. The brush assembly and mounting may be secured by a friction fit engagement.

### CROSS REFERENCE

The present application claims priority under 35 U.S.C. §119(e) to U.S. Provisional Patent Application Ser. No. 60/599,405, entitled: Bearing Support for Motors, filed on Aug. 6, 2004, which is hereby incorporated by reference in its entirety.

### FIELD OF THE INVENTION

The present invention generally relates to the field of motors and more particularly to a bearing mounting having an integrated brush holding capability and direct support for a stator, or field magnet, wire for universal motors.

### BACKGROUND OF THE INVENTION

Motors and in particular, universal motors proliferate everyday life in modern societies. Universal motors are particularly effective for utilization in devices in which size and weight are of concern. Power tools such as portable compressors, hand power tools (e.g., drills, circular saws, and the like), and the like typically implement universal motors. Due to the extensive use of motors in everyday situations, the efficient manufacture of these devices is critical. Assembly of the various motor components may require significant labor/expense to assemble. For example, the assembly of the shaft/brushes in a motor may require that the brushes be assembled prior to the motor/shaft assembly being incorporated into the housing. Additionally, brushes are assembled by inserting the components through an interior recess of a cap or housing. In a further example, the brushes may have to be positioned in an “open” or non-contacting position for connection of the motor shaft/commutator/rotor core into the mounting. Manufacturing a motor in this fashion may be time consuming as personnel are required to manipulate the components to ensure proper alignment. This may increase labor and the overall time required to assemble the motor.

Furthermore, current motors may require a significant number of electrical terminals (connections) to make the motor operable. Electrical connecting lead wires to the brushes in a motor may be time consuming and require the assembly of multiple components as part of motor assembly. In some instances, several wire ties are implemented to secure the lead wires to the main body of the brush. These procedures may decrease overall motor manufacturing capability and require personnel having high levels of dexterity and skill, as well as increasing the overall cost of the motor due to the inclusion of numerous terminals.

Therefore, it would be desirable to provide a motor mounting, a motor and a simplified and efficient method of manufacture.

### SUMMARY OF THE INVENTION

Accordingly, the present invention is directed to a motor mounting, motor, and a method of manufacture for simplified motor assembly.

In an aspect of the invention, a mounting for an electrical motor is described. The mounting may be formed of electrically insulating material and includes an end recess for accepting a bearing for supporting a received rotor shaft. The mounting includes a brush assembly receiving structure for accepting a brush assembly such as in a tool-less snap-fit securing arrangement. The motor mounting is configured so a brush assembly may be received from an exterior direction. In the foregoing instance, the mounting is configured such that a received brush assembly may be accepted from the exterior of the mounting and directed generally toward an interior recess constructed to accept the rotor. In a particular embodiment, a cleat may be formed on the housing for mechanically securing a field or stator lead wire.

In an additional aspect of the invention, a motor including a motor mounting and brush assembly is disclosed. The mounting includes a bearing recess for accepting a bearing for supporting a rotor shaft included in a rotor for being accepted in an at least partial recess formed by the mounting. The mounting further includes a brush aperture which extends from an outer surface of the mounting toward the at least partial recess for accepting the rotor in order for the brush assembly to be inserted from the outer surface. The brush assembly and mounting being configured to receive the brush assembly in a frictionally secured relationship.

In a further aspect, a method of manufacturing a motor includes the steps of securing a rotor shaft bearing to a motor mounting, inserting a rotor shaft included as part of the rotor into the bearing and assembling a brush assembly from the exterior of the mounting by inserting the brush toward the rotor.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an isometric view of a motor mounting in accordance with an aspect of the invention;

FIG. 2 is an exploded view of an electrical motor in accordance with an aspect of the invention;

FIG. 3 is an enlarged side elevation view of an electrical motor in accordance with an aspect of the invention, in which a mount includes a cleat for a stator lead wire;

FIG. 4 is a partial cut away view of an electrical motor in accordance with an aspect of the invention; and

FIG. 5 is a flow diagram illustrating a method of manufacturing a motor.

### DETAILED DESCRIPTION OF THE INVENTION

Reference will now be made in detail to the presently preferred embodiments of the invention, examples of which are illustrated in the accompanying drawings. It is to be appreciated that generally corresponding structures are provided with corresponding reference numbers.

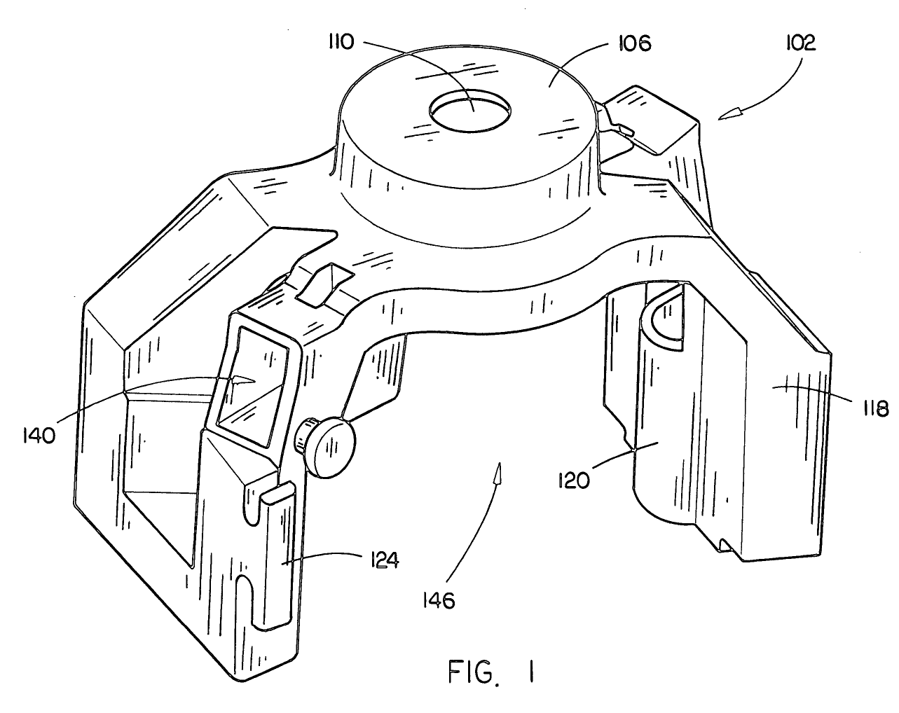

Referring to FIGS. 1 through 4, in the present embodiment of the invention, a motor mounting 102, included in an electrical motor 100, is discussed. An electrical motor 100 of the present invention may implement the mounting 102 for aiding in efficient assembly and repair. Further, a motor 100 in accordance with an aspect of the invention may permit the inclusion of a brush assembly 108 or a preassembled brush subassembly which may aid in efficient final assembly of the motor 100. Moreover, a motor 100 in accordance with the present invention may minimize the number of terminals required for coupling the stator or field wire to the brush assembly.

In the present embodiment, the mounting 102 is formed of a molded plastic. In additional embodiments, the mounting may be formed from a phenolic, a polymer/glass reinforced polymer, such as a phenolic with glass fill, or the like. Preferably, the mounting 102 is formed of an electrically insulating type material or a non-conductive material. Forming the mounting 102 from an insulating material may permit the implementation of lead wires which are not insulated. For example, a non-insulated or bare lead wire from the stator windings connected to a brush shunt may promote efficient assembly as insulation removal, or stripping of the wire, or utilization of a partially insulated wire is not required.

With reference to FIG. 1, the mounting 102 preferably includes a central or end portion 106 which defines a recess for accepting a bearing 104. In this manner, the bearing for the rotor shaft may be retained to the mounting 102 thereby providing a subassembly for overall final assembly of the motor 100. The bearing 104 may be secured to the mounting 102 by an adhesive material, retaining clips, fasteners, and the like for maintaining the position of the mounting/motor components in an exterior motor housing. In an additional example, a bearing may be disposed in an aperture extending through the central mounting and secured by retaining clips, fasteners, and the like. A through aperture 110 may be included in the mounting 102 for permitting a shaft 112, included in a rotor 116, to extend beyond the housing. For instance, the rotor shaft 112 may extend through the mounting 102 in order to couple a fan 114 to the shaft (for cooling heat generating motor components), aid in minimizing vibrations associated with rotation of the rotor 116 along the shaft, and the like.

In the present embodiment, support brackets 118 (one is referenced) extend outwardly from the end portion for securing the mounting in a motor housing, or the like. In further embodiments, the mounting 102 may be shaped as a partial cap or generally hollow cylinder for at least partially containing the rotor 116. For example, the mounting 102 may at least partially enclose the commutator 126, and/or the rotor winding 128. In the current example, the mounting including the end portion and support brackets are unitary. The support brackets 118 may extend generally away from the portion including the bearing recess, with the brackets directed so as to form a cap-like structure or partial enclosure forming a central recess 146 for encompassing at least a portion of the rotor 116. For example, the terminal portions of the support brackets are substantially parallel with a primary axis extending through the motor shaft 112 in order to accommodate stator components, promote efficient molding, and the like. Thus, the stator windings, or field windings, are generally coaxially disposed with respect to the rotor. For example, the wire windings forming the stator, or field, are wound and secured to the brackets by a plastic tie (i.e., a friction lock strip). The stator winding 122 may be secured to the interior surface of the bracket 118 to provide the desired gap between the stator and the rotor. The mounting 102 may be shaped to permit airflow over heat generating portions such as by including airflow openings in a support bracket. Additionally, a cross member 120 may be included in the bracket 118 for securing the stator components thereto, via a mechanical fastener, or the like. Those of skill in the art will appreciate the mounting/support brackets may be shaped as desired based on design preferences, to accommodate the functional requirements of the motor, to conform to an exterior motor housing, or the like. It is the intention of this application to encompass and include such variation.

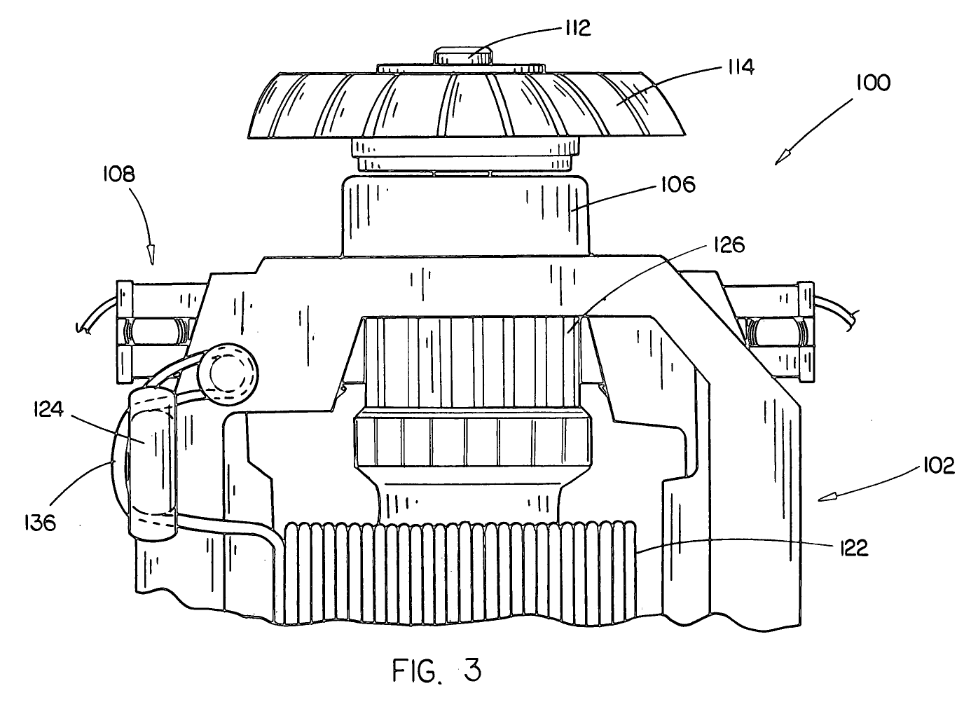

Referring now to FIG. 3, in a further embodiment, a cleat 124 and/or post may be included on the mounting in order to permit mechanical coupling of a stator lead wire electrically coupled to the field winding 122. Preferably, the cleat 124 is unitary with the mounting. Additionally, if the cleat is formed of insulating material the stator winding lead wire 136 may be un-insulated or bare. Inclusion of a mechanical structure such as a cleat 124 may allow for the securing the stator lead wire to prevent contact with other motor components, aid in assembling the lead wire 136 to a brush shunt, minimize vibration of the wire adjacent a terminal, and the like.

In an aspect of the invention, the mounting 102 defines a brush receiving structure for retaining a brush assembly 108 to the mounting. Two brush assemblies are illustrated, with the brush assemblies being substantially similar. Those of skill in the art will appreciate that multiple brush holders may be formed in the bearing support and be disposed (e.g., angular orientation or the like) to promote efficiency or other motor design factors. Preferably, the brush receiving structure permits assembly from an exterior of the mounting or away from a central 146, at least partial recess, for receiving a rotor and stator components. In this manner, the rotor may be preassembled to the mounting prior to the brush assembly being accepted to the mounting. Such configuration avoids the difficulties previously experienced. The mounting/brush assembly of the present invention may minimize the number of terminals required for assembly as multiple connections required for assembly through the central 146, or rotor, recess may be avoided.

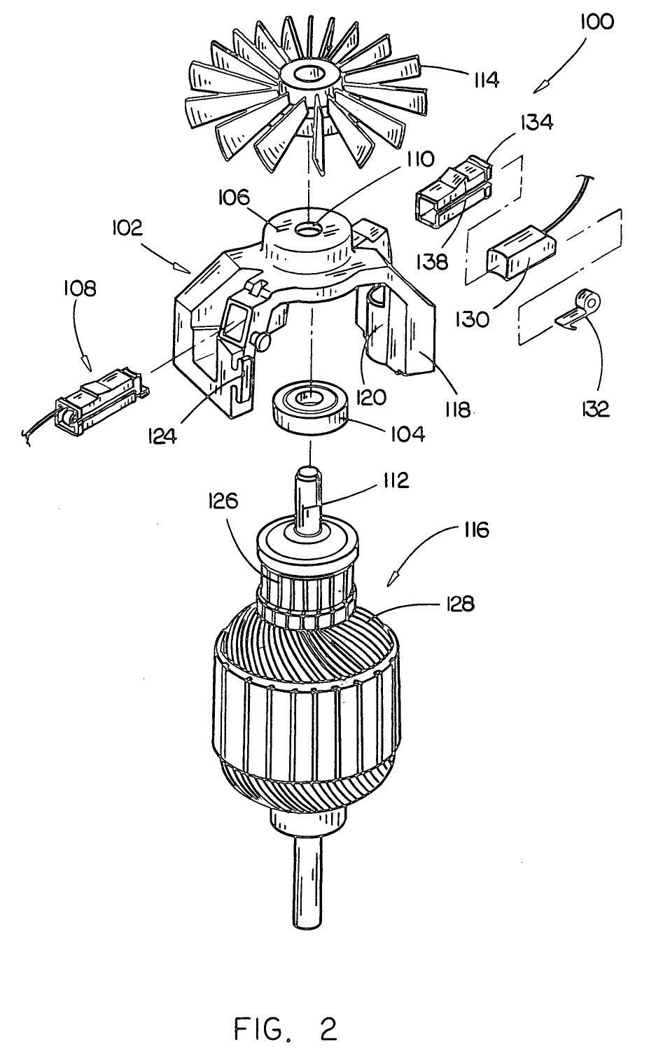

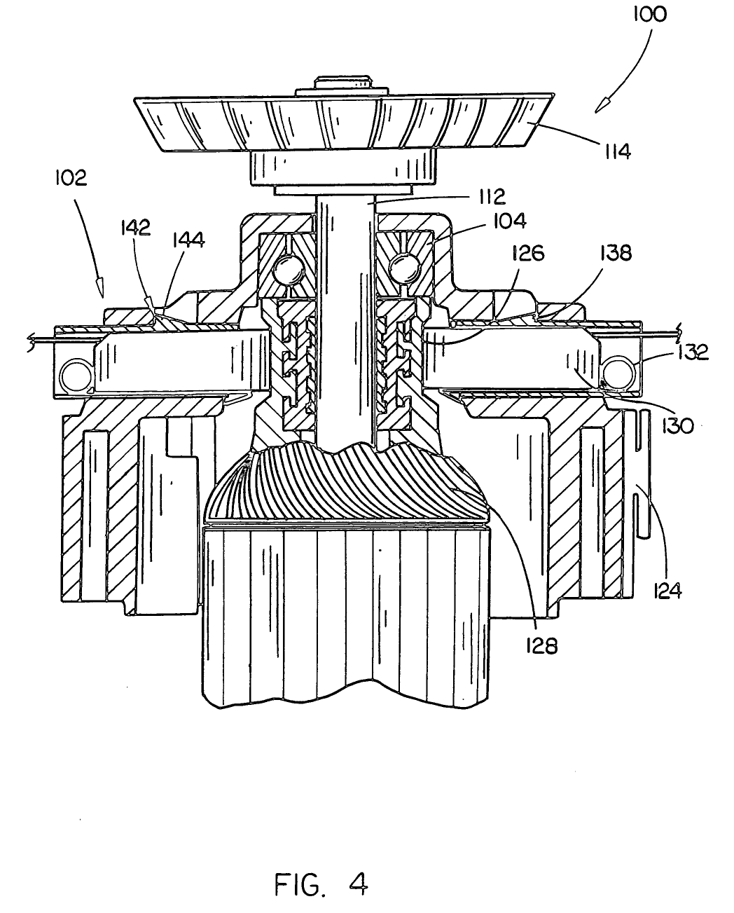

For example, the mounting includes a through aperture 140 (which extends radially away from the commutator 126, included in the received rotor 116) for accepting a brush assembly 108 including a brush housing 134. In the present embodiment, the aperture 108 has a generally rectangular cross-section. In additional examples, a through aperture is shaped as desired. In further embodiments, other suitable mounting structures include interconnecting grooves/rails formed on the mounting 102/brush assembly 108 and the like for securing the brush assembly are implemented. A tool-less mechanical securing mechanism may be included on the mounting 102/brush housing 134. For instance, the brush assembly is retained by a snap-fit device. With particular reference to FIGS. 2 and 4, one of the mounting 102 and the brush assembly, such as a brush housing 134, may include a detent 142 which catches a deformable tab 138 (e.g., a deformable tab unitarily formed with the brush housing 134) in order to secure the brush assembly in the mounting 102. A brush assembly 108 may be preassembled, such as with a brush and a brush spring, encompassed (at least partially) in a brush housing for holding the subassembly. An opening adjacent the detent may permit access to the tab 138 to remove the brush assembly. Those of skill in the art will appreciate a variety of mechanical structures may be implemented to secure the brush assembly to the mounting, it is the intention of this disclosure to encompass and include such variation. In additional embodiments, mechanical fasteners, such as screws and the like, an adhesive, and the like are utilized for securing the brush assembly.

A biasing device such as a roll spring 132 may be included in the brush assembly 108 for directing the brush 130 into contact with the commutator 126 contacts. For example, the roll spring 132 includes an end tab, which engages with the brush housing adjacent the contact portion of the brush 130 and may extend in a channel to engage a side of the brush 130 generally opposite the contact portion. The foregoing arrangement permits efficient brush removal for replacement without having to remove the brush assembly from the mounting 102. It is to be appreciated that a wide variety of biasing devices may be implemented. In alternative embodiments, a biasing device is implemented to bias the brush and brush housing which are fixedly secured. Preferably, the mounting is configured with integrated brush holders to allow for the insertion and retention of the motor brushes in proper orientation with respect to the motor shaft/commutator, such as for utilization in a universal motor.

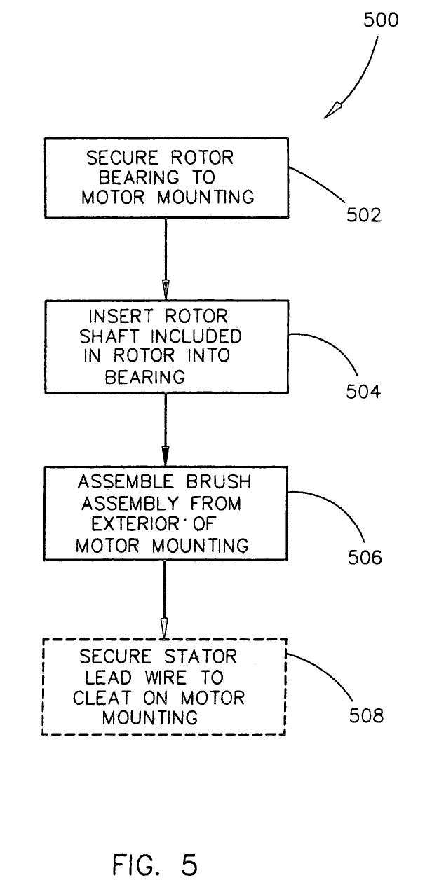

Referring to FIG. 5, a method 500 of manufacturing a motor in accordance with the present invention is described. In the present method 500, a rotor shaft bearing is secured 502 to a motor mounting. For instance, the motor bearing may be secured by a fastener, an adhesive, a mechanical interconnect, or the like to the motor mounting. A rotor shaft included in a rotor is inserted 504 into the rotor shaft bearing. The rotor shaft may be inserted through the bearing and motor mounting so as to permit securing of a fan for cooling the motor thereto. A brush assembly is assembled 506 to the motor mounting by inserting the brush assembly inwardly, toward a recess for receiving the rotor, generally from the exterior of the motor mounting. For example, the brush assembly may be inserted towards the previously received rotor via a groove and rail system, a through aperture, or the like. In this manner, the brush assembly is assembled subsequent to the assembly of the rotor. In the present example, the brush assembly is snap-fit to the motor mounting in order to secure the brush assembly in a tool-less fashion. In an additional embodiment, a stator wire is secured 508 to the motor mounting by a cleat included on the mounting.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A support for an electric motor, comprising:
a mounting being formed of electrically insulating material, the mounting defining an end recess for accepting a bearing for supporting a received rotor shaft, the mounting additionally defining a brush receiving structure for accepting a brush assembly,
wherein the mounting is configured to accept the brush assembly generally from an exterior of the mounting.

2. The support for an electric motor of claim 1, wherein the mounting is constructed to secure the brush assembly in a snap-fit engagement.

3. The support for an electric motor of claim 1, wherein the mounting includes a cleat configured for securing a stator lead wire to the mounting.

4. The support for an electric motor of claim 1, wherein the mounting is configured for mounting stator windings thereto, in a generally interior recess.

5. The support for an electric motor of claim 1, wherein the brush receiving structure for receiving the brush assembly is a through aperture extending from the exterior surface into a central recess for receiving the rotor shaft.

6. The support for an electric motor of claim 1, wherein the mounting includes a deformable tab for securing the accepted brush assembly to the mounting.

7. The support for an electric motor of claim 1, wherein the mounting is formed of a non-conductive thermoplastic.

8. The support for an electric motor of claim 1, wherein the mounting defines a through aperture configured to permit the shaft to pass through the end of the mounting including the bearing recess.

9. The support for an electric motor of claim 1, wherein the mounting includes a securing mechanism for securing the accepted brush assembly in the mounting.

10. The support for an electric motor of claim 1, wherein the mounting further defines at least one bracket extending generally away from the end recess, the at least one bracket being configured for mounting stator windings thereto.

11. A motor, comprising:
a mounting constructed for mounting a rotor therein, the mounting defining an at least partial recess for accepting the rotor, the mounting defining a bearing recess configured for retaining a bearing for mounting a shaft, included in the rotor, therethrough, the mounting defining a brush aperture extending generally from an exterior surface of the mounting towards the at least partial recess for accepting the rotor; and
a brush assembly configured for reception in the mounting brush aperture, the brush assembly and the mounting being configured for reception of the brush assembly from the exterior surface towards the at least partial recess for accepting the rotor,
wherein the brush assembly is frictionally secured in the mounting.

12. The motor of claim 11, wherein the brush assembly and mounting are secured by a snap-lock mechanism.

13. The motor of claim 11, wherein the mounting includes a cleat configured for securing a stator lead wire to the mounting.

14. The motor of claim 11, wherein the mounting is configured for mounting stator windings generally about the interior of the at least partial recess for accepting the rotor.

15. The motor of claim 11, further comprising stator windings, the stator windings electrically coupled to the brush assembly by a single terminal.

16. The motor of claim 11, wherein at least one of the mounting or the brush assembly includes a deformable tab for securing the accepted brush assembly to the mounting.

17. The motor of claim 11, further comprising means for biasing the brush assembly towards the at least partial recess for accepting the rotor.

18. The motor of claim 11, wherein the mounting further defines at least one bracket extending away from the bearing recess, the at least one bracket being constructed for supporting a stator winding.

19. A method of manufacturing a motor, comprising:
securing a rotor shaft bearing to a motor mounting;
inserting a rotor shaft, included in a rotor, into the rotor shaft bearing; and
assembling a brush assembly to the motor mounting by inserting the brush assembly from a direction exterior to the motor mounting towards the rotor.

20. The method of claim 19, wherein the step of assembling the brush assembly is subsequent to the insertion of the insertion of the rotor shaft into the rotor shaft bearing.

21. The method of claim 19, wherein assembly of the bush assembly includes snap-fit securing of the brush assembly to the motor mounting.

22. The method of claim 19, further comprising the step of securing a stator lead wire to a cleat included on the motor mounting.
